(19) United States
(12) Patent Application Publication
(10) Pub. No.: US 2004/0216010 A1
(43) Pub. Date: Oct. 28, 2004

(54) Electronically signed documents with examination software

(76) Inventor: Thomas Muller, Wiesloch (DE)

Correspondence Address: Finnegan, Henderson, Farabow,, Garrett & Dunner, L.L.P., 1300 I Street, N.W., Washington, DC, 20005-3315, US

(21) Appl. No.: 10/769,918

(22) Filed: Feb. 3, 2004

(30) Foreign Application Priority Data
Feb. 4, 2003 (DE) 10304412.4

(51) Int. Cl. H02H 3/05

(52) U.S. Cl. 714/38

(57) ABSTRACT

Electronically signed documents are provided with examination software. Digital documents are also provided that contain a digital signature, wherein the digital document comprises software for checking the digital signature.

### FIELD OF THE INVENTION

The present invention relates to digital documents and, more particularly, to digital documents having a digital signature.

### BACKGROUND OF THE INVENTION

Digital signatures are known, for example from DE 199 59764 A1. Digital signatures can be regarded as the counterpart of handwritten signatures. The digital signature put on an electronic document by a sender can be used to establish the identity of the sender and the authenticity of the sent document. The legally binding nature of digital signatures is an important subject for public administration, for companies, and to an increasing extent also for private individuals.

The principle of the digital signature is known. It is based on an asymmetric method, where each user has two different keys, a secret (private) key and a public key, with the public key being generally accessible. A prerequisite in this context is that each key pair is unique. The private key is used by the owner of the document or the sender to generate the digital signature. The receiver of a document signed with a digital signature can use an appropriate piece of software to separate the signature from the document and can use the sender's public key to decrypt the “hash” and hence, to check the authenticity of the document and the identity of the sender. This method can be used both between natural people and between hardware devices. In this context, the hash is a document extract value which is generated from the original document using a “hashing method.” It is signed (encrypted) using the sender's private key and is appended to the document as a digital signature. The check on the digital signature involves the use of an appropriate piece of software and the sender's public key first to calculate the original document's hash and second to reconstruct the hash from the digital signature. If the two values match, the document received has not been altered. For this method, however, the examining receiver of the document needs to have installed a piece of software which is dependent on the document type sent and on the signature used. Since this software is not contained in the document, the examining receiver needs to obtain this special software in some way and needs to install it. This is time consuming, involved and therefore results in additional costs. In addition, the examination software and the signature method, including the corresponding software, frequently change, which entails additional complexity for updating.

The keys and possibly the examination software are usually provided by a certified authority (certificate authority).

Thus, there is a need for documents, methods, software applications and/or data processing systems to provide a more efficient solution of at least a part of the problems described above. Particularly, it is desirable to provide documents having digital signatures and methods for producing such documents where the above drawbacks are at least partially not present.

The above description is based on the knowledge of the present inventors and not necessarily that known in the art.

Embodiments of the invention achieve the above-noted objects and others by means of a document of the type mentioned at the outset, wherein the document contains, for example, a piece of software for checking the digital signature.

### SUMMARY OF THE INVENTION

Embodiments of the invention are directed to digital documents having digital signatures, wherein the documents contain a piece of software for checking the digital signatures.

Embodiments of the invention are also directed to methods for creating a document in line with the invention, or computer systems containing the documents based on the invention. A computer system within the meaning of the invention can comprise just a computer (e.g., a personal computer (PC), laptop, customary peripherals, etc.), and can also comprise a network having a plurality of computers. This is also to be understood to mean a network which is formed using the Internet or an intranet.

Embodiments of the invention further comprise computer systems, computer programs and computer program products for carrying out the inventive methods. Embodiments consistent with the invention also comprise computer programs on or embedded in a data storage medium which can be used to load the programs into a computer and to carry out the inventive methods. The program can be in the form of source code, object code or mixed code, fully or partially compiled. Thereby, a computer system broadly refers to any stand alone computer, such as a PC or a laptop or a series of computers connected via a network, e.g., a network within a company, or a series of computers connected via the internet. Computer systems and programs may be closely related. As used herein, phrases, such as “the computer provides,” “the program provides or performs specific actions,” and “a user performs a specific action” are used to express actions by a computer system that may be controlled by a program or to express that the program or program module may be designed to enable the computer system to perform the specific action or to enable a user to perform the specific action by means of a computer system. In this context, the term “automatically” is not intended to exclude a user's interactions with the computer system in the course of processing.

The data storage medium can be any unit or apparatus which is suitable for containing a program: ROM, e.g., CD-ROM or a semiconductor ROM or DVD ROM; a magnetic storage medium, e.g., floppy disk or hard disk; a transferable medium, such as an electrical or optical signal which can be transferred via electrical or optical lines, or via electromagnetic waves, such as radio or radio waves; or another suitable medium. If the program is contained in a signal which is routed via a cable or another means or medium, the cable or the other means or medium can be the data storage medium. Alternatively, the program can be embedded in an integrated circuit provided for carrying out the inventive methods.

To provide for interaction with a user, the invention can be implemented on a computer system having a display device such as a cathode ray tube (CRT) or liquid crystal display (LCD) monitor for displaying information to the user, a keyboard, and a pointing device such as a mouse or a trackball by which the user can provide input to the computer. Other kinds of devices can be used to provide for interaction with a user as well. For example, feedback provided to the user can be any form of sensory feedback, such as visual feedback, auditory feedback, or haptic feedback, and input from the user can be received in any form, including acoustic, speech, or haptic input.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices (storage means) for storing data, e.g., magnetic, magneto-optical disks, or optical disks. Information carriers suitable for embodying computer program instructions and data include all forms of non-volatile memory, including by way of example semiconductor memory devices, such as EPROM, EEPROM, and flash memory devices, magnetic disks such as internal hard disks and removable disks, magneto-optical disks, and CD-ROM and DVD-ROM disks. The processor and the memory can be supplemented by, or incorporated in, application-specific integrated circuits (ASICs).

A document within the meaning of an embodiment of the invention is an electronic or digital file having any content. By way of non-limiting examples, this includes, in particular, electronic or digital faxes, letters, agreements, certificates, invoices, orders and order confirmations, tax assessments and much more.

According to an embodiment of the invention, software can be called-up using a pointer. This pointer or this activation means can be in a known form and, in particular, also in the form of a button on a display apparatus. However, the pointer can also just contain information relating to the access by the examination software which is able to be read by a program, for example by a Java script, and is able to be used for loading the examination software. Such a program can be started by the user in a known manner, for example using a file selection menu or using a button. It is also advantageous if the digital document has a format which can be taken as a basis for displaying it in a web browser. It is also advantageous if the format is an HTML, XML or PDF format.

Embodiments of the invention are also directed to digital documents, wherein the digital document comprises an invoice. Depending on the signature and procedure used, the design of the digital document can be such that either the signature contains the invoice document in encrypted form or that, besides the invoice document, only the actual signature is incorporated into the complete document. The process can also have other parties involved in it which handle the digital documents. In this case, every party involved in the process is not just able to display the document, but can also examine the signature. The pointer to the examination software does not imperatively have to point to a third party (e.g., a provider of the examination software), but can also go directly to the invoice issuer, i.e., the invoice issuer then also undertakes the role of the provider. In one particular refinement of the invention, the examination software can also be part of the document.

The invention is explained in more detail below with reference to the accompanying drawings. This is not intended to limit the invention in any way.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a schematic illustration of a computer system having a document in line with an exemplary implementation of the invention and suitable for carrying out an exemplary implementation of the inventive method;

FIG. 2 illustrates a use of a document and a method in line with an exemplary implementation of the invention;

FIG. 3a illustrates a method for creating a document in line with an exemplary implementation the invention; and

FIG. 3b illustrates a method for extracting and examining the original document in line with an exemplary implementation of the invention.

### DESCRIPTION OF THE EMBODIMENTS

Reference will now be made in detail to the present exemplary embodiments of the invention, examples of which are illustrated in the accompanying drawings. Wherever possible, the same reference numbers will be used throughout the drawings to refer to the same or like parts.

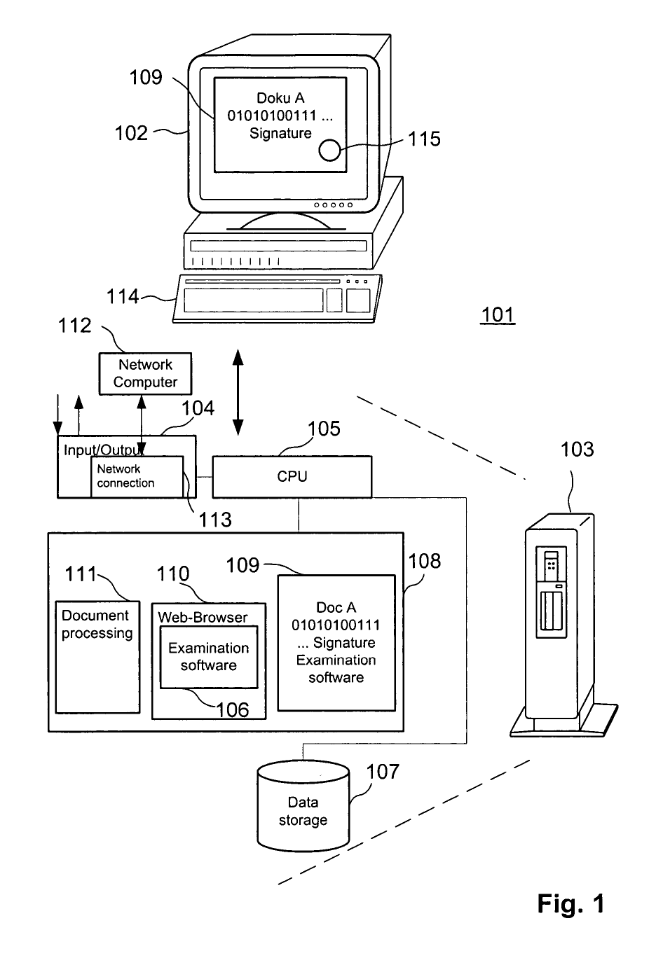

FIG. 1 shows a computer system 101 including a computer 103, which comprises a CPU 105, and a main memory 108 including a piece of software 111 and a web browser 110 loaded in it for execution by the CPU 105. Computer system 101 further comprises input means 113 and output means 102, e.g., a monitor. The software 111 may comprise one or more known programs or program modules which are suitable for handling and processing documents, for digitally signing such documents and for merging documents, signatures and pointers, for example the Acrobat software from Adobe Systems Inc., San Jose, Calif., USA. The main memory also stores a digital document 109 based on embodiments of the invention which is displayed on the output means 102, e.g., a monitor, by a web browser 110. The computer system 101 also comprises a network connection 104 for connecting the computer 103 to further identical or different computers 112 or computer systems in the form of a network, with the network computers 112 being able to be used as further input and/or output units for inputting and/or outputting data and for presenting input masks or for outputting results or for executing software. The computer system 101 may also include a data store 107 for permanently storing data, including the digital documents 109 based on embodiments of the invention. Digital documents 109 may contain program code for an activation means 115 for activating the examination software if the document is presented by web browser 110 on output means or monitor 102. In the example shown, the activation means may be implemented in the form of a button.

Such a computer system can be used to carry out the inventive methods, as described below by way of example, without limiting the invention in any way thereby.

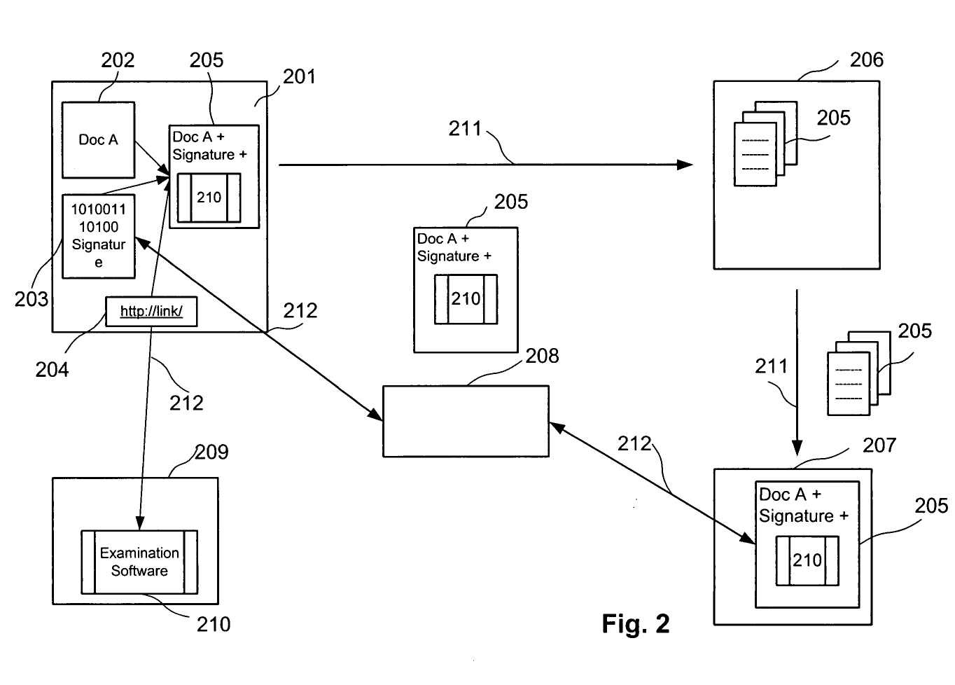

FIG. 2 illustrates, by way of example, the generation of a digital document based on an exemplary implementation of the invention and the use of the digital document using a block diagram which shows an interconnection comprising a plurality of users and their connections. Users may be, with a computer system in each case, an originator or sender 201 of a document 205 based on the invention, a first receiver 206 of one or more documents 205, a second receiver 207, who receives the one or more documents 205 from the first receiver 206, a certified authority 208 and also a software provider 209.

In the sender's computer system 201, an original document 202 is first produced. This is signed with a digital signature 203 and is merged together with a piece of examination software 210 to form a digital document 205 based on the invention. This document 205 can have any formats which can be presented in a web browser, for example HTML, PDF, and XML formats and also text files. The document 205 can be a digital invoice, for example. The examination software 210 can be provided by a software provider via a hyperlink 204 which points to a server 209 of the software provider on which the examination software is stored and is accessible for download. The sender 201 sends one or more documents 205 to the first receiver 206 via a connection 211. The connection 211 can be a network connection, e.g., via the Internet or via an intranet, or else a mail connection which is used to send the digital document, stored on a data storage medium. The first receiver 206 can store the received documents 205 in his computer system. Upon execution, he can alternatively forward them via a further connection 211 to a second receiver 208.

To check the originality of the received documents 205, the first receiver 206 and/or the second receiver 207 may display each received document 205 using a web browser. Upon display in the web browser, the second receiver 207 is presented with a switch or button to activate the examination software 210. The examination software 210 can be in the form of a Java applet or Java script or in the form of an ActiveX control, for example. A Java applet can be loaded and executed directly in the browser. The examination software 210 then examines the signature on the digital document 205 and displays the result (e.g., document matches or does not match original) to the second receiver 207 on the display unit.

This will be clarified further in the example below using possible handling of invoices and also forwarding thereof to a finance officer or authority, with reference to FIG. 2.

When an invoice receiver 206 requests an invoice 202 from an invoice issuer 201, or the invoice issuer 201 which is to send an invoice 202 to the invoice receiver 206 electronically (without being prompted), this can proceed in the following manner:

The invoice issuer 201 generates the invoice 202 in a desired format which can be displayed using a browser (HTML, XML, PDF, . . . ). The invoice issuer 201 signs this invoice with a signature 203. Next, the invoice issuer 201—provided that he does not already have the examination software stored at his location—loads the examination software 210 for this signature 203 and for the document type used using the link 204 from the software provider 209.

The invoice issuer then merges these three elements 202, 203,210 in an HTML document to form a digital document 205. From a technical point of view, this can be done, by way of example, by virtue of an invoice 202 being transferred to the complete HTML document 205 unchanged in HTML format. The signature 203 can be accommodated in HTML comments with start and end markers, as can the examination software 210.

The invoice receiver 206 collects the digital documents 205 (e.g., invoices during the year). In doing so, he can look at the content of the invoice document 202 at any time. When the complete document 205 has been compiled, e.g., in line with the above action, the invoice receiver 206 sees the HTML invoice 202 with a pointer 204 to the examination software 210. This means that the invoice 202 can be viewed without using the examination software 210. The invoice receiver 206 can then transfer the digital document(s) 205 to a finance authority 207.

The finance authority 207 can view the documents 206 transferred by the invoice receiver 206 in a web browser. If he now wishes to check the authenticity or original faithfulness of the document 202, he can activate a button or switch or a similar activation means presented to him in the web browser's display. A Java applet or Java script can then be activated and executed directly in the browser.

The applet, for example, now accesses the original document (invoice) again (e.g., transferred as parameter when the applet is called). In the applet, the original invoice document is now separated from the signature and is transferred to the signature examination (contained in the applet).

The signature examination now examines the signature against the document and may need to contact the certified authority in this process in order to test the authenticity of the signature.

The applet now gives the finance authority the response regarding whether the signature is valid and whether the invoice document is in the original state.

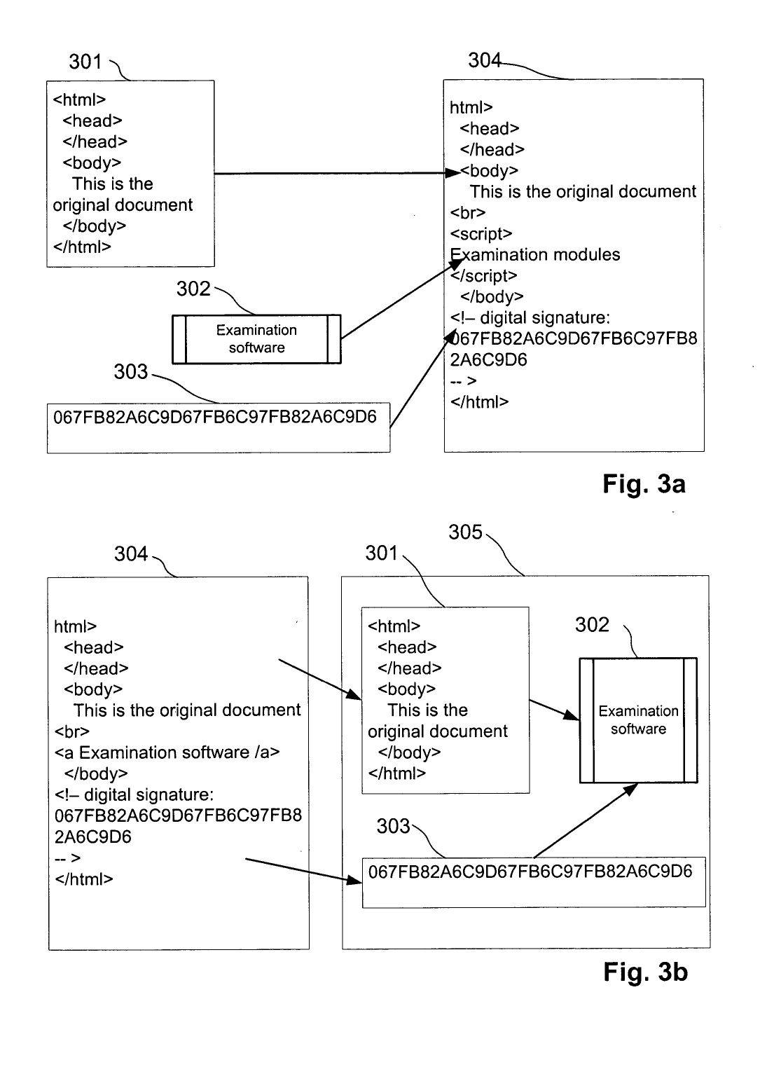

FIGS. 3a and 3b show a respective example of a method based on an exemplary implementation of the invention for automatically creating a document based on an embodiment of the invention and a method for automatically extracting and examining the document using an exemplary implementation of the inventive pointer.

Programs for generating a document 304 may take as input an original document 301 (e.g., in HTML format), a signature 303 generated using known methods and a piece of the examination software 302.

In one embodiment, the program for generating the document 304 may first generate a new HTML document 304 which is still empty (FIG. 3a). It then may insert the original document 301 into the new document 304 and the examination software 302. Next, it may analyze the HTML code and insert an activation button at the end of the document body. These insertions may be marked, so that the examination software can remove a coding added with the insertion again. Next, the signature 303 may be inserted into an HTML comment at the end of the complete document. This HTML comment can contain a particular keyword from which the examination software 305 can later identify where the signature 303 can be found in the document 304.

In another embodiment, if the user clicks on the button, the Java applet, for example, is automatically called up (FIG. 3b). It may break down the document and identify from the key words where the button has been inserted. The latter is removed. In addition, the signature 303 is separated from the document. The document is now in the original state again, as at the time of signing.

The examination software now calls up an examination routine 306 and first transfers to it the document in this original state and the separated signature. The examination routine checks the document, and gives the result to the examination software (Java applet), which presents the result.

In this case, the programs can be in a form, as is known, such that one or more of the steps cannot be performed until after there has been interaction between the program and a user. By way of a non-limiting example, the original document can first be selected by user in a known file selection dialog provided by the program.

An advantage of digital documents based on embodiments of the invention and the procedures described is that the user-in the example the second receiver 207—does not need to have any examination software installed on his computer system in advance. The originator or sender of the document, who signs the document, can even store in the document which examination software needs to be used. Displaying the digital document based on embodiments of the invention requires no special additional software, since the format used can be processed by any current web browser.

It will be noted that when features are linked by “or”, the term “or” is respectively to be understood firstly as being a mathematical “or” and secondly as an “or” which excludes the respective other possibility.

It will also be pointed out that the statements relating to all known arrangements which do not refer to particular printed documents are known primarily to the applicant or inventor, which means that the applicant or inventor reserves the right to protect them provided that they are not also known to the public.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus- function or step-plus-function limitations will only be employed where for a specific claim limitation all of the following conditions are present in that limitation: a) “means for” or “step for” is expressly recited, b) a corresponding function is expressly recited, and c) structure, material or acts that support that structure are not recited.

Computer programs based on the written description and flow charts of the embodiments of this invention are within the skill of an experienced developer. The various programs or program modules can be created using any of the techniques known to one skilled in the art or can be designed in connection with existing software. For example, programs or program modules can be designed in or by means of ®Java, C++, HTML, XML, or HTML with included Java applets or in SAP R/3 or ABAP. One or more of such modules can be integrated in existing e-mail or browser software.

Modifications and adaptations of the present invention will be apparent to those skilled in the art from consideration of the specification and practice of the embodiments of the invention disclosed herein. The foregoing description of an implementation of the invention has been presented for purposes of illustration and description. It is not exhaustive and does not limit the invention to the precise form disclosed. Modifications and variations are possible in light of the above teachings or may be acquired from the practicing of the invention. For example, the described implementation includes software, but systems and methods consistent with the present invention may be implemented as a combination of hardware and software or in hardware alone. Additionally, although aspects of the present embodiments of the invention are described for being stored in memory, one skilled in the art will appreciate that these aspects can also be stored on other types of computer-readable media, such as secondary storage devices, for example, hard disks, floppy disks, or CD-ROM; the Internet or other propagation medium; or other forms of RAM or ROM. It is intended that the specification and examples be considered as exemplary only, with a true scope and spirit of the invention being indicated by the following claims.

What is claimed is:

1. A digital document containing a digital signature, wherein the document comprises a piece of software for checking the digital signature.

2. The digital document of claim 1, wherein the software can be called up using a pointer.

3. The digital document of claim 1, wherein the digital document has a format for enabling the digital document to be displayed in a web browser.

4. The digital document of claim 3, wherein the format is at least one of an HTML, XML, or PDF format.

5. The digital document of claim 1, wherein the software is contained in the digital document.

6. A method of generating a digital document, the method comprising the steps of:
creating a digital signature for an original document;
generating the digital document from the original document; and
adding the digital signature and a piece of software for checking the digital signature.

7. A method for checking a digital document containing a digital signature, wherein the document comprises a piece of software for checking the digital signature, the method comprising:
executing the software contained in the document.

8. The method of claim 6, wherein the original document is selected from the group comprising of digital faxes, letters, agreements, certificates, invoices, orders, order confirmations, and tax assessments.

9. A computer system comprising a digital document according to any of claims 1 to 5.

10. A computer system for generating a digital document containing a digital signature, wherein the document comprises software for checking the digital signature, the computer system comprising:
means for storing data;
means for storing programs;
means for executing programs; and
program code means for performing a method of generating a digital document when executed by the means for executing programs, the method comprising:
creating a digital signature for an original document;
generating a digital document from the original document; and
adding to the digital document the digital signature and software for checking the digital signature.

11. A computer program product comprising program code means for performing a method of generating a digital document when executed on a computer, the method comprising:
creating a digital signature for an original document;
generating a digital document from the original document; and
adding to the digital document the digital signature and software for checking the digital signature.

12. An electrical carrier signal comprising a computer program product according to claim 11.

13. A computer program product having program code means for causing a processor of a computer to check a digital document containing a digital signature, the document comprising software for checking the digital signature, the computer program product causing the computer to execute the following step:
executing the software contained in the document.
